(19) United States
(12) Patent Application Publication
(10) Pub. No.: US 2003/0229790 A1
(43) Pub. Date: Dec. 11, 2003

(54) System and method for electronic ticket purchasing and redemption

(76) Inventor: William Christopher Russell, Sterling, VA (US)

Correspondence Address: William Russell, 1108 East Maple Avenue, Sterling, VA, 20164, US

(21) Appl. No.: 10/425,984

(22) Filed: Apr. 30, 2003

Related U.S. Application Data
(60) Provisional application No. 60/376,228, filed on Apr. 30, 2002.

(51) Int. Cl. H04L 9/00

(52) U.S. Cl. 713/172; 705/65

(57) ABSTRACT

A system and method for purchasing, issuing and redeeming electronic tickets using portable information device (“PID”) technology. Utilizing the accessibility, convenience, and fraud protection features of PIDs, embodiments of the present invention store identification information on a user's PID, and then, utilizing a ticket server and an authentication device, provide mechanisms to access the PID in order to authenticate and/or validate the user.

### RELATED APPLICATIONS

This application claims the benefit from U.S. provisional application Serial No. 60/376,228 filed on Apr. 30, 2002, the disclosures of which are incorporated herein by reference.

### FIELD OF THE INVENTION

The present invention relates generally to the field of electronic commerce using portable information devices such as smart cards, personal digital assistants, and the mechanisms used to access these devices. More specifically, the invention relates to systems and methods for using portable information devices to facilitate electronic business transactions. Even more particularly, the invention concerns systems and methods for electronically posting, reserving, purchasing, authenticating and redeeming tickets and vouchers using portable information devices employing public key cryptography.

### BACKGROUND OF THE INVENTION

Every day throughout the world, consumers conduct multi-phase business transactions with suppliers. At each phase of these business transactions, one of the parties may demand that another party to the transaction provide some level of authentication or identification. Additionally, a party may require, as a condition of entry into a multi-phase business transaction, that certain forms of authentication be performed at some or all subsequent phases of the transaction.

Authentication of multi-phase business transactions may be accomplished in a variety of ways incorporating a wide range of sophistication and accuracy. An example of low-sophistication, low-accuracy authentication is a simple cash transaction in which the critical factor is the authenticity of the cash itself. At the other extreme, a high-sophistication, high-accuracy transaction might be a special event, where notification of the event is by secret invitation, payment is required in advance and admittance is conditioned upon verification of biometric information, such as that obtained through a retinal scan or DNA sample.

In recent years, portable information devices and integrated circuit cards such as smart cards have emerged as effective devices for facilitating many different types of transactions, as well as for providing a secure means to store the information required by those transactions. In particular, portable information devices have been used to facilitate entry into ticketed events by storing the required ticket information within the device's memory.

Without loss of generalization, the term portable information device (“PID”) will be used herein to refer to a portable device having a built-in microprocessor and memory, capable of being programmed to store and access personal identifying information and/or financial transaction information, and able to create and/or validate digital signatures and/or digital certificates. Examples of portable information devices include portable computers, hand-held computers, integrated circuit cards, smart cards, mobile computing devices, cellular telephones, personal digital assistants (“PDAs”), wireless pagers and the like.

Similarly, without loss of generalization, the term “ticket” will be used herein to refer to a document, which may be maintained in electronic form, that serves as a certificate, license or permit. For example, a ticket may be a label for identification. A ticket may also correspond to a token showing that a fare has been paid or that a means of access or passage has been granted. A ticket may additionally record a business transaction or may document an agreed contractual undertaking or may provide instructions corresponding to a specific individual or group of individuals, such as may be provided by a traffic ticket or summons.

Again, without loss of generalization, the term “consumer” will be used herein to refer to a customer, consumer, member, attendee or person who acquires a ticket according to embodiments of the present invention.

According to known online ticketing techniques, a ticket is stored on a PID by communicating to the PID the data required to fully describe the ticket, including where necessary administrative information, individual identification information, special instructions, financial data, a venue, a date and time of a scheduled event, and seating information. The PID may also store proof of payment as well as ticket refund information. When a valid PID ticket holder arrives at the scheduled event, the PID is interfaced to an appropriately-configured PID terminal and ticket information located on the PID is extracted and verified. After the ticket is authenticated, the PID terminal may then erase the ticket information from the PID, or may otherwise mark the ticket information as redeemed by any number of methods known in the art.

Known methods for issuing tickets using PIDs require the ticket information to be stored on the PID itself. Indeed, this local storage is perceived to be a benefit. Once the ticket information has been stored on the PID, ticket authentication and validation can then be accomplished simply by communicating with the PID, first to exchange and authenticate the appropriate identifying information and security keys, and then to transfer the specific ticket information directly from the PID to the ticketing terminal.

However, while such known methods for issuing and redeeming tickets may appear convenient, they require the PID to store the ticket information. For this reason, when a ticket is purchased, the PID must be inserted into a PID interface terminal, which must communicate with the PID to transfer the required ticketing information. Thus, known methods for issuing and redeeming a given ticket using PID technology require that a consumer either travel to the location of a PID interface terminal or possess a PID interface terminal that is able to communicate with a central ticketing system. Additionally, known PID ticketing methods do not permit external control, modification, and validation of the ticket information stored on the PID.

Accordingly, there is a need in the art for a system and method for purchasing, issuing and redeeming tickets using PID technology, that meets the basic needs of accessibility, convenience, and fraud protection, and which does not require ticket information to be transferred to the PID, but nevertheless retains the security features of personal information devices and related technology.

### SUMMARY OF THE INVENTION

Embodiments of the present invention are directed to a system and method for purchasing, issuing and redeeming electronic tickets using portable information device (“PID”) technology. Utilizing the accessibility, convenience, and fraud protection features of PIDs, embodiments of the present invention store user identification information on a user's PID, and then, utilizing a ticket server and an authentication device, provide mechanisms to access the PID in order to authenticate and/or validate the user.

In other aspect, embodiments of the present invention provide a method and system to update a ticket server with authentication data associated with a venue and then share the authentication data with an authentication device. The embodiments include establishing a communication between a consumer's PID and the authentication device, and deciding whether to grant the consumer access to the venue based on the communication.

In yet another aspect, embodiments of the present invention provide a method and system to update a ticket server with authentication data associated with the status and/or identity of a registered individual, and sharing the authentication data with at least one authentication device. The embodiments include establishing a communication between the PID and one of the authentication devices, and authenticating, based on the communication, the status and/or identify of the registered individual.

Other systems, methods, features and advantages of the invention will become apparent to one skilled in the art upon examination of the following figures and detailed description. It is intended that all such additional systems, methods, features and advantages included within this description are within the scope of the invention, and are protected by the accompanying claims.

Unless specifically stated otherwise as apparent from the following discussions, it is understood that terms such as “processing” or “computing” or “calculating” or “determining” or “displaying” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission or display devices.

### BRIEF DESCRIPTION OF THE DRAWINGS

FIG. 1 is a high-level block diagram of a ticketing system for purchasing, issuing and redeeming electronic tickets using portable information device (“PID”) technology, in accordance with an embodiment of the present invention.

FIG. 2 is a representative drawing of a PID, according to an embodiment.

### DETAILED DESCRIPTION OF THE INVENTION

Embodiments of the present invention will be described in reference to the accompanying drawings, wherein like parts are designated by like reference numerals throughout, and wherein the leftmost digit of each reference number refers to the drawing number of the figure in which the referenced part first appears.

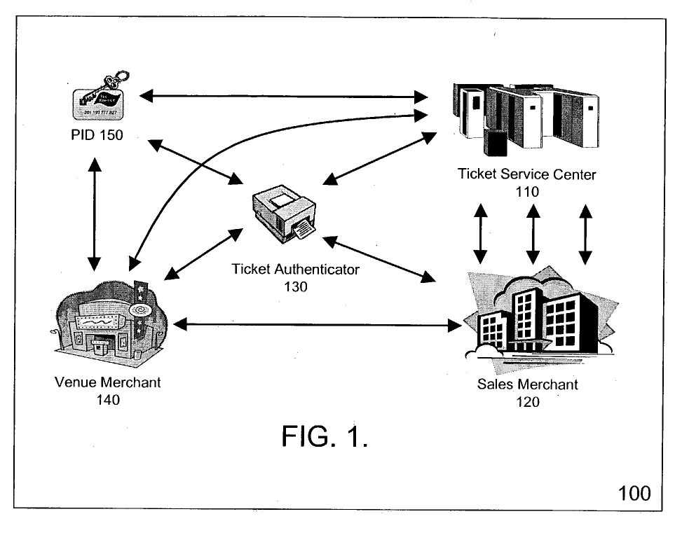

FIG. 1 is a high-level block diagram of a ticketing system 100 for purchasing, issuing and redeeming electronic tickets using portable information device (“PID”) technology, in accordance with an embodiment of the present invention. Ticket system 100 may include five functional entities: ticket service center 110, sales merchant 120, ticket authenticator 130, venue merchant 140 and portable information device (“PID”) 150 employing public key cryptography.

Ticket Service Center 110

With reference to FIG. 1, ticket service center 110 may include a set of network and database servers that together maintain an active database of sold and unsold ticket assets. Ticket service center 110 may serve multiple roles. However, its primary functions are to broker and service tickets. In those capacities, ticket service center 110 carries out several related tasks. Ticket service center 110 may receive requests to market and sell tickets from sales merchant 120. Ticket service center 110 may receive orders from sales merchant 120 to create new tickets, update existing tickets, or delete existing tickets. When authorized by sales merchant 120, ticket service center 110 may offer tickets for sale to consumers over the Internet (not shown). Alternatively, other methods known in the art may also be used to offer tickets for sale to consumers. Ticket service center 110 may sell tickets to consumers over the Internet, as well as via other avenues known in the art. As part of its ticket selling task, ticket service center 110 may associate a consumer's PID 150 with a newly-purchased ticket. If a purchasing consumer does not yet possess a PID 150, ticket service center 110 may first issue a new PID 150 to that consumer. As tickets are sold, ticket service center 110 may execute and record ticket sales transactions in its database. When a consumer presents a PID 150 to redeem a previously-issued ticket, the consumer—or someone on the consumer's behalf—may insert PID 150 into ticket authenticator 130 for authentication. Ticket authenticator 130 may then transmit an authenticated ticket request message to ticket service center 110. When ticket service center 110 receives the authenticated ticket request message, ticket service center 110 may execute and record a ticket redemption transaction, and return to ticket authenticator 130 a ticket redemption message directing ticket authenticator 130 either to authenticate or reject the ticket redemption request. Upon request by sales merchant 120, ticket service center 110 may reconcile ticket sales transactions and ticket redemption transactions, and may issue various reports to the sales merchant 120. In each of these tasks, ticket service center 110 may update its central database to reflect the new state of the transaction made.

Continuing to refer to FIG. 1, ticket service center 110 may include a collection of distributed processors, some of which may be redundant. Some redundant processors may enable portions of the ticket service center 110 to communicate more efficiently with other components of the system. Other redundant processors may function as backup units that come on-line when a processor fails or requires maintenance. Still other redundant processors may simply provide added computational power at peak demand periods, such as when many tickets are being redeemed at a scheduled event.

As part of its ticket sales task, ticket service center 110 may advertise tickets for sale using any number of advertising techniques known in the art. Ticket service center 110 may also cooperate with auctioning systems, such as eBay, to assist in the transfer of a previously-sold ticket from one consumer to another. Furthermore, ticket service center 110 may provide ticket trading and exchange services directly. Whenever ticket service center 110 transfers a previously-acquired ticket from one consumer to another, it may disassociate a first consumer's PID 150 from a ticket, and then associate a second consumer's PID 150 with that same ticket.

Ticket purchases may occur through an Internet web interface, although ticket purchases are certainly not limited to this medium. During a purchase, a consumer may present a previously-issued PID 150 account number and password, and pay for the ticket. In the ticket service center 110 database, the purchased ticket is associated with the consumer's account number. The purchased ticket is also associated with a public key corresponding to the consumer's PID 150. After a ticket is sold, it is then marked “sold” in the database.

Additionally, the term “purchase,” as used herein is intended to include the acquisition of a ticket without the transfer of money. That is, the price of a ticket may be zero ($0.00).

Sales Merchant 120

As further illustrated in FIG. 1, sales merchant 120 may post tickets for sale with the ticket service center 110. This transaction is called a vendor post. As alluded to previously, a vendor post is simply a process whereby a ticket or groups of tickets are made available for sale. To affect a vendor post, sales merchant 120 may negotiate with ticket service center 110 the right to sell a ticket. This negotiation is accomplished, in part, by sales merchant 120 submitting to ticket service center 110 all the necessary details for the ticket. These details may include price, seat number, redemption date, redemption time, and venue merchant. A ticket posting may be accomplished interactively, ticket by ticket. A ticket posting may also be accomplished in groups, wherein aggregate data describing collections of tickets are transmitted to ticket service center 110. When ticket service center 110 accepts a vendor post, it transmits a vendor post acknowledgement signal to sales merchant 120.

As will be appreciated by one of skill in the art, sales merchant 120 and venue merchant 140 may be the same entity in actual fact.

Sales merchant 120 may elect to withdraw a vendor post by instructing ticket service center 110 to remove a specific ticket (or group of tickets) from the ticket service center 110 database of active tickets. A removed ticket need not be purged from the ticket service center 110 database. Instead, a removed ticket may be simply marked as “inactive.”

A ticket post may also be made by a consumer who wishes to resell a ticket. This is a different kind of ticket post that does not create a new ticket, but instead may change the state of an existing ticket from “sold” to “for resale.”

After sales merchant 120 completes a vendor post, sales merchant 120 informs ticket service center 110 about all the possible ticket authenticators 130 that may be granted permission to redeem the posted tickets. Sales merchant 120 may also inform ticket service center 110 about certain conditions under which tickets may be redeemed. For example, sales merchant 120 may authorize ten specific ticket authenticators 130 to redeem tickets for a designated event in a particular window of time. In this example, the event description might include a unique event identifier created and registered by sales merchant 120. Once the unique event identifier is associated with the appropriate ticket authenticators 130 and the appropriate tickets, if sales merchant 120 requires changes to be made to the event, sales merchant 120 could use this unique event identifier to communicate the appropriate changes to ticket service center 110.

Ticket authenticator 130 may close an event by sending sales merchant 120 a list of all the ticket redemptions made for a given event. Sales merchant 120 may then collate this list of all the ticket redemptions with similar lists sent to sales merchant 120 by other ticket authenticators 130 governing the event.

After collating all the ticket transactions for an event, sales merchant 120 may reconcile received ticket redemptions with ticket service center 110. By reconciling the data received from ticket authenticators 130 and similar data received from ticket service center 110, sales merchant 120 protects itself from error or fraud by identifying any uncorroborated ticket redemption transactions.

PID 150

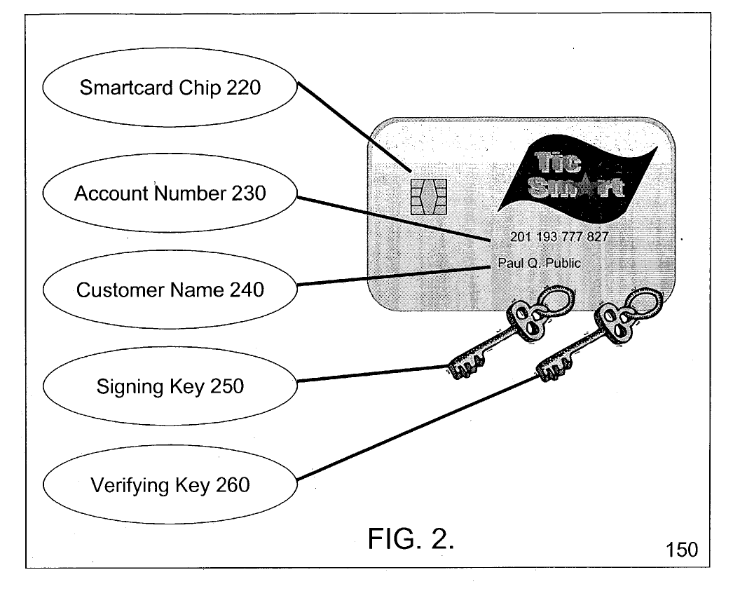

FIG. 2 is a representative drawing of PID 150, according to an embodiment. Referring now to FIG. 2, each consumer may possess a PID 150 (see also FIG. 1). PID 150 may include a digital signature key set, which is used to authenticate ticket purchases. The key set includes a private signing key 250 used for signing a transaction, and another public verifying key 260 for verifying the signature. Signing key 250 is unique to each PID 150 and is not externally accessible. However, verifying key 260 is made publicly available. Verifying key 260 is commonly referred to as a public key, and it is stored at ticket service center 110 (FIG. 1) with its associated consumer account.

Of course, one kind of PID 150 may differ in its capabilities from other kinds of portable information devices. Therefore, one PID 150 may be more suitable for one or more embodiments of the present invention, but not as suitable for other embodiments.

Ticket Authenticator 130

Referring again to FIG. 1, ticket authenticator 130 is a processing device, such as a computer, which may have a display, a PID terminal, a printer, and network connectivity. The primary function of ticket authenticator 130 is ticket redemption. However, ticket authenticator 130 may also communicate with sales merchant 120 to reconcile ticket redemptions.

According to an embodiment, to redeem a ticket, a consumer first engages his/her PID 150 with the ticket authenticator 130. Ticket authenticator 130 then creates and signs a ticket request message, and transmits this ticket request message to the consumer's PID 150. A ticket request message may contain the following elements:

Ticket Request Message
Event Identifier (e.g. Movie name)
Time and Date
Ticket Authenticator Public Key
Ticket Authenticator Digital Signature

In return, ticket authenticator 130 receives an authenticated ticket request message from the consumer's PID 150. At this stage, the authenticated ticket request message has been dually authenticated with the signing key of ticket authenticator 130 as well as the signing key 250 of the consumer's PID 150. An authenticated ticket request message may contain the following elements:

Authenticated Ticket Request Message
Event Identifier (e.g. Movie name)
Time and Date
Ticket Authenticator Public Key
Ticket Authenticator Digital Signature
PID 150 Public Key
PID 150 Digital Signature

After ticket authenticator 130 receives an authenticated ticket request message from PID 150, it sends the dually authenticated ticket request to the ticket service center 110. According to an embodiment, ticket service center 110 may perform a series of validation tests to determine whether the authenticated ticket request message is valid. If any of the validation steps fail, ticket service center 110 may deny the authenticated ticket request. Validation tests may include the following: Is the ticket authenticator 130 public key valid? Is the PID 150 public key valid? Is the ticket authenticator 130 digital signature valid? Is the PID 150 digital signature valid? Are the date and time fields valid? Is this ticket authenticator 130 authorized to redeem a ticket for this event?

If ticket service center 110 determines that the authenticated ticket request message is valid, ticket service center 110 may respond with a ticket redemption message. A ticket redemption message may contain the following elements:

Ticket Redemption Message
Authenticated Ticket Request Packet
Ticket Contents (Names, Seating, etc . . . )
Transaction Number
Transaction Time
ticket service center 110 Digital Signature1
ticket service center 110 Digital Signature2

Once a ticket has been redeemed by ticket service center 110, ticket authenticator 130 may validate the ticket redemption message and then may print a receipt for the consumer, which may include seating, price, and other ticket information. The ticket redemption message may be recorded at both ticket authenticator 130 and the ticket service center 110.

Ticket authenticator 130 may close an event by sending sales merchant 120 a list of all the ticket redemption messages received for the event. Sales merchant 120 may collate these transactions with other ticket authenticator 130 operating at the event.

Venue Merchant 140

Continuing to refer to FIG. 1, venue merchant 140 may grant consumers access to an event, or may otherwise admit attendees having authenticated tickets.

Venue merchant 140 may sell tickets. To do so, venue merchant 140 may issue PID 150 cards to consumers. When venue merchant 140 performs this ticket-selling function, it may coordinate its ticket selling activities with ticket service center 110.

Venue merchant 140 may also interact with sales merchant 120 to coordinate ticket redemption. Prior to a ticket redemption event, or whenever a ticket redemption process is appropriate, venue merchant 140 may initiate operation of the necessary ticket authenticators 130, may communicate event status to ticket service center 110, and may perform other event-related and venue-related functions.

Ticketing System 100

According to an embodiment, ticketing system 100 may provide access to concessions within an event. A ticket may include financial information, which may be accessed and debited as a result of a consumer-initiated purchase using PID 150 at an appropriate event.

According to another embodiment, ticketing system 100 may provide purchasing authorization to members of a club, where a purchased ticket corresponds to a set of purchasing permissions, including spending limits and credit authorizations.

According to still another embodiment, ticketing system 100 may provide identity authentication for applications such as driver's licenses, VISAs, and passports.

According to still another embodiment, ticketing system 100 may provide identity authentication as well as spending authorization for meal plans and school payment systems.

According to still another embodiment, ticketing system 100 may be used to authenticate transactions where pictures, biometric information, and other personal identification information may be provided either by PID 150 itself or by another device used in combination with PID 150.

Several embodiments of the present invention are specifically illustrated and described herein. However, it will be appreciated that modifications and variations of the present invention are covered by the above teachings and within the purview of the appended claims without departing from the spirit and intended scope of the invention. Other logic may also be provided as part of the ticket redemption process but are left out here so as not to obfuscate the present invention.

What is claimed is:

1. A method for granting access to a PID holder, comprising:
receiving an authenticated request from a PID;
transmitting the authenticated request to a service center;
receiving from the service center a redemption message responsive to the authenticated request; and
granting access to the PID holder based on the received redemption message.

2. A method for redeeming a previously purchased ticket, comprising:
communicating an event ticket request to a PID;
receiving from the PID an authenticated event ticket request responsive to the event ticket request;
transmitting the authenticated event ticket request to a ticket validation center;
receiving from the ticket validation center a ticket redemption responsive to the authenticated event ticket request; and
validating the ticket redemption.

3. The method of claim 2, wherein said event ticket request comprises:
an event identifier;
a date-time value;
an authenticator public key; and
an authenticator digital signature.

4. The method of claim 3, wherein said authenticated event ticket request comprises:
the event identifier;
the date-time value;
the authenticator public key;
the authenticator digital signature;
a public key unique to the PID; and
a digital signature unique to the PID.

5. The method of claim 4, wherein said ticket redemption comprises:
a ticket content;
a ticket transaction number;
a ticket transaction date-time value; and
at least one digital signature.

6. The method of claim 5, wherein the validating step of claim 1 further comprises:
validating at least one of the digital signatures;
verifying that the ticket transaction date-time is within a previously determined range; and
generating a ticket redemption message.

7. The method of claim 6, further comprising:
refusing access to the PID holder when at least one of the digital signatures fails to validate; and
refusing access to the PID holder when the ticket transaction date-time is not verified.

8. A product redemption system, comprising:
a portable information device with a storage means for storing consumer account information and consumer authentication data, said consumer authentication data including a public cryptographic key and a private cryptographic key;
a sales merchant;
a purchase service center;
a purchase authenticator;
means for posting to the purchase service center a request to sell a product;
means for offering said product for advance purchase;
means for reserving an advance purchase of said product;
means for initiating a product redemption for said product in conjunction with said portable information device;
means for uniquely identifying said portable information device using public key cryptography; and
means for receiving said product based on said product redemption.

9. The system of claim 8, wherein the portable information device comprises a smart card.

10. The system of claim 8, wherein the portable information device comprises a hand-held computer.

11. The system of claim 8, wherein the portable information device comprises a integrated circuit card.

12. The system of claim 8, wherein the portable information device comprises a mobile computing device.

13. The system of claim 8, wherein the portable information device comprises a cellular telephone.

14. The system of claim 8, wherein the portable information device comprises a personal digital assistant.

15. The system of claim 8, wherein the portable information device comprises a wireless pager.

16. The system of claim 8, wherein the purchase service center includes:
means for storing said posted requests;
means for selling said products; and
means for authenticating said product redemption.

17. A method for redeeming a previous ticket purchase, comprising:
receiving an authenticated ticket request containing an event identifier, an event public key, an event digital signature, a PID public key and a PID digital signature;
validating the event public key;
validating the event digital signature;
validating the PID public key;
validating the PID digital signature;
retrieving a previously-purchased ticket associated with the event identifier, said previously-purchased ticket corresponding to an account number associated with the PID public key; and
transmitting a ticket redemption responsive to the authenticated ticket request.

18. The method of claim 17, further comprising: validating the ticket redemption.
